(19) United States
(12) Patent Application Publication
(10) Pub. No.: US 2013/0126755 A1
(43) Pub. Date: May 23, 2013

(54) Method and device for simultaneous multi-channel and multi-method acquisition of synchronized parameters in cross-system fluorescence lifetime applications

(71) Applicant: Klaus Kemnitz, Neusalza (DE)

(72) Inventor: Klaus Kemnitz, Neusalza (DE)

(73) Assignee: EUROPHOTON GESELLSCHAFT MBH FUER OPTISCHE SENSORIK, Berlin (DE)

(21) Appl. No.: 13/303,254

(22) Filed: Nov. 23, 2011

(51) Int. Cl. G01N 21/64

(52) U.S. Cl. 250/459.1; 250/458.1; 250/200; 250/208.1

(57) ABSTRACT

A device for simultaneous multi-channel, multi-method acquisition of synchronized parameters in fluorescence lifetime applications is provided with a fluorescence macroscope, microscope or nanoscope, a pulsed laser source, a beam splitter, a TSCSPC detector, and a synchronized peripheral device. A sample is irradiated with a pulsed, high frequency, polarized or unpolarized ps or ns laser beam. The fluorescence radiation from the sample is guided onto a beam splitter to generate two partial beams that are deflected onto a list-mode detector operating by space- and time-correlated single photon counting. All physical parameters of each photon are acquiring by the list-mode detector simultaneously and saved in control electronics. Simultaneously, further parameters are acquired in synchronization by a peripheral device and saved. The saved parameters of the list-mode detector and of the peripheral device are combined to a multi-parameter, multi-method acquisition system in a 1-file method.

### BACKGROUND OF THE INVENTION

The invention concerns a method and a device for simultaneous generation of time-resolved and space-resolved fluorescence images on the basis of time-correlated and space-correlated single photon counting for cross-system multi-parameter determination of samples in a synchronized multi-channel as well as multi-method configuration.

Fluorescence-spectroscopic measuring methods gain increasingly in importance because of high detection sensitivity and specificity, in particular in biotechnological and medical diagnostics; however, combinations with independent methods are desirable in order to increase the number of observed parameters that describe the examined system as completely as possible.

Cells have the property to emit a characteristic fluorescence after irradiation with short-wave light. Responsible for this behavior are in particular cell-inherent molecules that participate in metabolism, such as nicotinamide adenine dinucleotide (NADH), flavines, porphyrins. The emission spectrum of cell-inherent fluorescence can extend from the blue to the red range of the visible spectrum (400-700 nm). The cell-inherent DADH fluorescence can serve as an indicator for cell metabolism.

However, this so-called auto fluorescence can also be very disruptive because it is omnipresent in case of measurements of living cells and overlies the fluorescence of the external or cell-fabricated fluorescence samples, the emission band of the auto fluorescence is very broad (>2,000 cm<−1>, in contrast to the spectrum of normal fluorescence samples, e.g. GFP with approximately 1,500 cm<−1>), and, moreover, the fluorescence dynamics is multi-functional (≧3 components for FAD (K. Kemnitz et al., J. Fluorescence 7 (1997) 93)).

In order to excite fluorescence, the fluorophores are irradiated with monochromatic light near the adsorption maximum. As excitation sources, either filtered lamps or lasers are used. By spectral filtration of the emission, the desired fluorescence band is selected.

Moreover, laser-induced fluorescence signals in general can be evaluated for characterizing an object to be examined, for example, solutions or surfaces of solid bodies.

The conventional methods for fluorescence detection are static methods that supplies information in regard to intensity for a limited number of emission wavelengths (e.g. two. such as in “ratio imaging”) or represents even the static fluorescence spectrum in each individual space pixel in a modern 3-D spectroscopy method (Spectral Diagnostics Ltd., P.O. Box 147, Migdal Haemek, 10551 Israel).

In regard to the temporal subsiding behavior of the fluorescence, no conclusions can be derived in general.

In order to increase the sensitivity and selectivity of the static fluorescence measuring methods, recently the fluorescence lifetime imaging microscopy (FLIM) has been developed that is employed in the phase domain and time domain.

The phase domain employs a periodic modulation of the laser excitation and/or emission detection.

The time domain employs pulsed lasers and represents a direct method in contrast to phase fluorometry that requires transformation of the phase space into the time space.

Methods and arrangements for generating time-resolved fluorescence images in the “time domain” are known.

A known method is the method “ZOKEPZ” (“zeit-und ortskorrelierte Einzelphotonenzählung” or in English “TSCSPC” (time- and space-correlated single photon counting) (K. Kemnitz et al.: Time- and Space-Correlated Single Photon Counting Spectroscopy, SPIE Proc., 2628 (1995) 2.) which is a further development of “ZKEPZ” (“zeit-korrelierte Einzelphotonenzählung”) or in English “TCSPC” (time-correlated single photon counting) (D. V. O'Connor and D. Phillips, 1984, Academic Press) and the method “TCSPC in combination with a point-scan mechanism” (Becker and Hickl GmbH, Nahmitzer Damm 30, 12277 Berlin).

TSCSPC is superior in all comparable methods in all ranges as e.g. dynamic range, time resolution, and high quality kinetics, with the exception of quantum efficiency of the photocathode (CCD is better).

The time-correlated single photon counting (TCSPC and TSCSPC) exhibits ultra-sensitivity, an extremely high dynamic range of >10<6> and high quality kinetics (at up to 16,000 points on the time axis) combined with a time resolution of up to 2 ps (after deconvolution).

The method “TCSPS in combination with a point scan mechanism” has the disadvantage that, at the focus of the single point that is scanned repeatedly across the sample, very high peak power is existing that either leads to cell damage (two-photon absorption: K. König et al., Cell damage in two-photon microscopes, Proc. SPIE, 2926 (1996) 172) or to undetected photodynamic reactions and thus to erroneous fluorescence dynamics in living cells (single photon absorption: K. Kemnitz et al., EC Demonstration Project BIO4-CT97-2177).

In addition, there is also a third method that employs a switchable (gated) CCD camera (LaVision BioTech GmbH, Höfeweg 74, 33619 Bielefeld). The CCD technology, however, is unsuitable for complex applications because of the minimal dynamic range and the small number of points on the time axis.

MCP detectors with special anodes are used that provide simultaneously space and time information. These space-resolving anodes for MCP detectors are embodied as delay-line (DL) anodes, crossed DL (XDL), wedge-and-strip (WS) anodes, crossed strip anodes, quadrant anodes (QA) and multi anodes (MA) (Stepanov et al, SPIE) that are employed in vacuum applications (i.e., without photocathode) (M. Lampton and R. F. Malina, Quadrant anode image sensor, Rev. Sci. Instr., 47 (1976) 1360; C. Martin, P. Jelinsky, M. Lampton, R. F. Malina, Wedge-and-strip anodes for centroid-finding position-sensitive photon and particle detectors, Rev. Sci. Instr., 52 (1981) 1067) as well as in MCP-PMTs (DL and MA, Stepanov et al., SPIE).

QA and MA can be manufactured of conducting or non-conducting material and differ in their properties.

Generally, one speaks of coded anode (CA) detectors when they measure charges and, by means of segmented anodes, determine the space coordinates: wedge-and-strip (WS) anode, QA, MA, crossed-strip etc. By using a DL anode (measurement of the running time difference of two electrical impulses), a photomultiplier (PMT) with photocathode (single photon detector) was developed that is suitable very well for linear applications (Eldy Ltd.: Simultaneous spectral and temporal resolution in single photon counting technique, M. R. Ainbund et al., Rev. Sci. Intr., 63 (1992) 3274); U.S. Pat. No. 5,148,031) or for imaging applications when crossed (2-dimensional) DL anodes are used (RoentDek GmbH, Im Vogelshaag 8, 65779 Kelkheim; O. Jagutzki et al., Fast Position and Time Sensitive Readout of Image Intensifiers for Single Photon Detection, Proc. SPIE, 3764 (1999) 61; U.S. Pat. No. 6,686,721).

Moreover, a 4-anode-QA-MCP-PMT (4QA) (conducting anode) has been developed (Eldy Ltd.; EuroPhoton GmbH in the project INTAS-94-4461) that however exhibits image distortions and a limitation of the field of view (M. Lampton and R. F. Malina, Quadrant anode image sensor, Rev. Sci. Instr., 47 (1976) 1360; C. Martin, P. Jelinsky, M. Lampton, R. F. Malina, Wedge-and-strip anodes for centroid-finding position-sensitive photon and particle detectors, Rev. Sci. Instr., 52 (1981) 1067).

DE-G 94 21 717.3 discloses a device for time- and space-resolved fluorescence or scattered light spectroscopy with a pulsed radiation source, a radiation splitter, a unit for space resolution, a unit for temporal resolution in which the radiation source has correlated therewith an object to be examined and a reference object and that has at least one device that links optically a polychromator with the sample or the reference (no microscope application).

EP 1 291 627 A1 discloses a method and an arrangement method for simultaneous generation of time-resolved fluorescence images (fluorescence lifetime imaging) and time-resolved emission spectra, based on time- and space-correlated single photon counting (TSCSPS: time and space correlating single photon counting) for determination of parameters of samples such as living cells, in multi-well, in-vitro fluorescence assays, in DNA chips, in which a pulsed, high-frequency, polarized laser beam is guided onto a fluorescence sample and the fluorescent light that is emitted by the fluorescence sample is deflected onto a beam splitter (intensity, color or polarization splitter) and is split therein into two partial beams, wherein in the two beam branches at least two TSCSPC-based list-mode detectors are combined to a multi-parameter acquisition system with which, for maximum information gain, simultaneously all physical parameters of each single photon are acquired and saved and evaluated in control electronics. Such a system is capable of simultaneously providing ps/ns time-resolved images of fluorescence intensity, fluorescence lifetime and fluorescence anisotropy, including diffusion trajectories. The proposed system enables however only a single channel measurement.

Moreover, it has been proposed to realize a multi-parameter acquisition on the basis of a widefield TSPSPC application in that, in addition to the list-mode parameters, also parameters of peripheral systems are included, wherein these parameters are synchronized (Stepanov et al., Widefield TSCSPC-Systems with Large-Area-Detectors: Application in simultaneous Multi-Channel-FLIM, Proc. SPIE 7376, 73760Z (2010)).

Despite the continuous development in the field of fluorescence lifetime applications, there is still a need for further linking of the data generated by fluorescence lifetime imaging with other detection methods in order to be able to determine, by means of cross-system correlation of such data, new conclusions in regard to structural and functional conditions of the sample to be examined.

The list-mode data storage of the classical TSCSPC method contains the following parameters of each individual event: space coordinates x and y (or the TAC or TDC time differences upon which it is based in case of DL or the individual charges in case of MA detectors), the correlated time difference Δt (time difference between single quantum and the next excitation laser pulse) as well as the absolute arrival time t(abs), measured by means of a quartz clock for the number of periodic laser pulses.

The object of the present invention resides therefore in that a device and a method are to be provided that enable quantitative linking of simultaneously detected parameters which have been obtained by means of several synchronized but independent methods.

### SUMMARY OF THE INVENTION

The object is solved by a device according to claim 1 and a method according to claim 9. Advantageous embodiments are disclosed in the dependent claims.

According to the invention, the device has an arrangement (fluorescence micro-, macro-, and nano-spectroscope) for producing time-resolved and space-resolved fluorescence images based on time-correlated and space-correlated single photon counting (TSCSPC) for determining parameters in samples such as living cells, in multi-well, in-vitro, fluorescence assays, DNA chips, comprising
a fluorescence microscope, fluorescence macroscope, fluorescence nanoscope
at least one pulsed laser source
at least one beam splitter,
at least one TSCSPC detector (space-correlated and time-correlated single photon counting detector), as well as
at least one synchronized peripheral device.

By use of at least one beam splitter, at least two beam branches are generated which can then be detected by at least one TSCSPC detector.

The term peripheral system or the term periphery is meant to include all electronically controllable modules of a nanoscope, microscope or macroscope. For example, in the case of an epi/TRIF fluorescence microscope, they can be the following modules:
position of an excitation or emission filter wheel
position of the dichroic carousel
position of the output port
z position of the lens
xyz position of a nano-translation stage or micro-translation stage
epi position or TIRF position wherein both ports can be excited by different lasers
color of an electronically controlled color filter (e.g. AOTF, acousto-optical tunable filter).

In one embodiment of the invention, the device comprises moreover a synchronized external system for determining further parameters of the sample wherein the external system is embodied or modified to detect the parameters in synchronization and comprises at least one pulsed or non-pulsed laser as external device.

In one embodiment of the invention, when using only one TSCSPC detector, both images that are obtained by the beam splitter can be imaged simultaneously onto one and the same photocathode adjacent to each other.

In one embodiment of the invention, the at least one TSCSPC detector has an anode which is selected from a group consisting of DL anodes, crossed DL (XDL), wedge-and-strip (WS) anodes, crossed strip anodes, quadrant anodes (QA) and multi-anodes (MA).

In a further embodiment of the invention, a color splitter and a polarization splitter can be connected in series so that four partial images are obtained in a square arrangement. This arrangement enables real-simultaneous dual anisotropy imaging. When in this context two or four sets of crossed DL or other space-imaging anodes are used adjacent to or on top of each other, it is possible to carry out two or four channel coincidence imaging with only one detector head. Optical 4-channel imaging is possible for large surface area detectors of 25-40 mm diameter.

In one embodiment of the invention, the device comprises TSCSPC detectors wherein the latter are employed alternatively for simultaneous or sequentially use with simple or imaging polychromators (also scanning confocal polychromator systems). Alternatively, also gated CCD detectors can be used that, as external devices, can be synchronized.

In one embodiment of the invention, the at least two partial beams are guided onto at least two TSCSPC detectors. The TSCSPC detectors can be designed such that one of the TSCSPC detectors in the first branch measures time-resolved emission spectra while the second TSCSPC detector in the second branch records time-resolved fluorescence images.

In one embodiment of the invention, in the first branch either a linear DL detector can be used (provides a spectrum of the center of the sample) or imaging detectors (XDL, WS, 4 QA, 5QA, CA, gated CCD) that simultaneously deliver up to 250 individual spectra, along the diagonal through the sample (use of an imaging polychromator as a dispersion element). In the second branch either a linear DL detector can be used (delivers a line image through the center of the sample) or imaging detectors (XDL, WS, 4QA, 5QA, CA, gated CCD).

In one embodiment of the invention, the arrangement is characterized in that a first detector is provided with a linear delay line (DL) (simple polychromator) or with crossed delay line (XDL), QA, WS or general CA anode but also with a gated CCD (imaging polychromator) and is arranged behind the beam splitter, a dispersion element and a neutral filter as well as a polarization filter in the beam path of the first branch of the emitted fluorescent light and in that, as a second detector, an XDL, 4QA, 5QA, WS or CA-MCP-PMT (also gated CCD) is employed and is arranged behind the beam splitter and a neutral filter as well as color and polarization filter in the beam path of the second branch of the emitted fluorescent light.

In a further embodiment of the invention, the device comprises moreover pulsed or nonpulsed lasers for manipulation and activation whereby e.g. laser trapping and photo switch applications become possible.

In one embodiment, the external system comprises a scanning probe microscope, laser scanning cytometer, a confocal one-photon or two-photon laser scanning microscope, a color CCD camera, a b/w CCD camera, a gated CCD camera, in combination with RGB filters in a synchronized filter wheel, the color of an electronically controlled color filter (e.g. AOTF, acousto-optical tunable filter), a laser in a multiple laser excitation (e.g. color of an electronically controllable ps continuum laser) which can be directly controlled (diode laser, Fianium) or can be controlled by shutters, fiber switchers that control fiber-coupled lasers, the properties of one or several additional manipulation lasers (trapping, cutting, activation, conversion, bleaching), xyz position and correlated measured values of a scanning probe microscope (SPM), rotating Nipkow disk with microlenses (e.g. Yokogawa CSU-x1), laser beam modifiers such as 3-D-SIM and PAM microscopy, as examples of illumination with structured light, ROI (region of interest) and other properties of a confocal scanning spectrograph (e.g: Nikon C1-si) or rotators for control of circular neutral filters for adjusting the laser intensity, prisms for rotation of the polarization direction.

In a further embodiment, the beam splitter is an intensity, color or polarization splitter. In an embodiment of the beam splitter as a color splitter (dichroic mirror) that e.g. separates the FRET donor and FRET acceptor emission bands, a FRET system can be configured that does not lose any photons because polychromators and color filter are not needed. A dichroic mirror (dichroic mirror) in the context of the present invention is a mirror that reflects only a portion of the light spectrum and allows the remainder to pass. In this connection, this mirror separates the incident light according to wavelength and thus according to color. On the other hand, in an embodiment of the beam splitter as a polarization splitter that separates the parallel and perpendicular polarization directions, a loss-free anisotropy system can be configured because polarization filters are not needed.

In a further embodiment, the device comprises moreover at least one Nipkow disk. A Nipkow disk in the context of the present invention refers to a disk with holes in spiral arrangement with which images can be split into light and dark signals and combined again. The rotating disk migrates line by line across the image (for splitting) or the projection surface (when recombining). It is provided with spirally arranged square holes.

Both beam paths (beam branches) can be used simultaneously or sequentially, but also separately when e.g. the auto fluorescence problem is neglectable or very well understood and the time-resolved spectrum is not needed for FRET verification.

With the arrangement according to the invention, a multi-parameter fluorescence microscope can be configured that simultaneously can measure and save all available physical parameters (space coordinates x and y, Δt (TAC), t(abs), polarization and wavelength) of each individual photon. By synchronized acquisition of the parameters of external devices of another method and adjustments of the arrangement, such as parameters of the CCD camera, position of a filter wheel and/or of a dichroic carousel, color of an electronically controlled color filter, laser in a multiple laser excitation (color of an electronically controllable ps continuum laser), properties of one or several additional manipulation lasers (trapping, cutting, activation), xy position and z parameters of a scanning probe microscope (SPM), position of a nanoscope, microscope or macroscope xy translation stage, laser beam modifiers (structured illumination), rotating Nipkow disk with microlenses etc., each individual event, in addition to the direct physical parameters of the respective single photon, can be correlated with the synchronized parameters of external devices and the adjustments of the arrangement.

The time correlation of the at least one TSCSPC detector is realized by means of a TAC (time-to-amplitude converter) or TDC (time-to-digital converter) as well as by means of standard electronic modules (e.g. CFD etc. as they are used in standard single photon counting according to the prior art). The respective TAC or TDC measures the time difference between starting signal (fluorescence photon) SS and a common stop signal StS (of the laser pulse that generated the fluorescence photon).

The individual events are cached in control electronics, sorted and synchronized and subsequently saved by a smart interface and synchronizer in a PC in sequence (list-mode) but can also be processed to histograms that can then be saved quickly and so as to save memory space.

The TSCSPC detectors are capable of simultaneously determining space (or wavelength) coordinates and time coordinates and the control electronics can save additional parameters such as polarization direction, emission wavelength, absolute arrival time etc. of each individual event. Since all measured parameters of each individual photon as well as the synchronized parameters of the external devices as well as the adjustments of the arrangement are available on hard drive, any type of diagram can be generated which correlates the individual parameters relative to each other (replay mode) and thus enables novel applications such as e.g. xy-space resolved single-channel or multi-channel ps/ns dynamic fluorescence applications, TSCSPC nano-tracking, TSCSPC-PSF (point spread function) analyses: TSCSPC-Palmira-FLIN (photoactivated localization microscopy with independently running acquisition-fluorescence lifetime imaging nanoscopy), TSCSPC-STICS (spatio-temporal image correlation spectroscopy), TSCSPC-OLID (optical-lock-in detection), TSCSPC-PALM/FPALM (photoactivation light microscopy), TSCSPC-STORM (stochastic reconstruction optical microscopy), TSCSPC-STED (stimulated emission depletion), TSCSPC-PAM (programmable array microscope), optical sectioning microscopy (structures illumination), TSCSPC-FRAP (fluorescence recovery after photo-bleaching), TSCSPC-FRET (Förster energy resonance transfer) or TSCSPC-SPM, as functional-structural correlation in combination of data e.g. of an AFM (as a component of the synchronized peripheral system) with those of a widefield TSCSPC-system).

In this way, novel methods are generated which are enabled by application of the multi-channel, multi-method and cross-system multi-parameter acquisition and replay of the list-mode data sets. In addition to the TSCSPC-FLIM information, one obtains in this context the correlated information of the respective independent additional method:
TSCSPC nano-tracking: ps/ns FLIM+tracking of individual molecules, Qdots and nano domains with 1 nm resolution, based on Gauss fits and xy determination of the centroid,
TSCSPC-PSF (point spread function) method: ps/ns-FLIM+nanometer distance measurement, based on Gauss fits of individual molecules, Qdots and nano domains of different color,
TSCSPC-Palmira (photoactivated localization microscopy with independently running acquisition-fluorescence lifetime imaging nanoscopy), ps/ns-FLIM+subresolution fluorescence images,
TSCSPC-PALM/FPALM (photoactivation light microscopy), ps/ns-FLIM+subresolution fluorescence images,
TSCSPC-STORM (stochastic reconstruction optical microscopy), ps/ns-FLIM+subresolution fluorescence images, wherein PALM/PALMIRA/STORM are examples of the aforementioned photo switching microscopy that are based on activation/deactivation of photoswitchable molecules,
TSCSPC-STICS (spatio-temporal image correlation spectroscopy): ps/ns FLIM+temporal-spatial correlation for determining diffusion constants, aggregation, and other intracellular properties of the fluorescing molecule,
TSCSPC-OLID (optical lock-in detection): ps/ns-FLIM+selective observation of a desired molecule amongst other molecules of high fluorescence background;
TSCSPC-STED (stimulated emission depletion): ps/ns-FLIM+subresolution fluorescence images,
TSCSPC-SIM (structured illumination microscopy): ps/ns-FLIM+subresolution fluorescence images,
TSCSPC-PAM (programmable array microscope): ps/ns-FLIM+subresolution fluorescence images, wherein SIM and PAM are an example for application of the structured illumination in fluorescence microscopy/spectroscopy;
TSCSPC-FRAP (fluorescence recovery after photo-bleaching): ps/ns-FLIM+diffusion behavior of biomolecules in the living cells, based on bleaching of the chromophores by an optical manipulation laser and observation of the recurrence of fluorescence,
TSCSPC-FRET (Förster energy resonance transfer): ps/ns-FLIM+FRET verification by simultaneous observation of donor emission and acceptor emission and their intensity ratio as well as alternating laser excitation of donor and acceptor,
TSCSPC-SPM: ps/ns-FLIM+measured values of a synchronized probe microscope, for example, AFM. The TSCSPC-AFM combination provides function (TSCSPC)-structure (AFF) correlations that are not accessible otherwise;
TSCSPC-CALM: ps/ns-FLIM+complementation-activated light microscopy for selective detection of individual molecules in the natural environment of the living cells.

Polarization and color filters can be controlled manually or optionally electromechanically or electronically and are connected by the control electronics and synchronizer.

The neutral filters can also be electromechanically controlled and can be connected to the control electronics/synchronizer.

Opto-electronic color and polarization filters can be controlled in the ms range; in contrast thereto, standard filters electromechanically by timing in seconds (pseudo simultaneously). However, for a measuring duration in the minute range, this is equivalent to a simultaneous acquisition. By use of several lasers with different wavelengths and/or color and polarization filters, multi-channel acquisition systems can be constructed that, as a result of pseudo-simultaneous measurement, enable comprehensive data acquisition for fluorescence applications. By multi-channel acquisition as a result of the synchronized parameter acquisition in particular by the external devices and by appropriate combination possibility of the individual parameters in replay mode, novel conclusions with respect to functional and structural correlations of the sample can be generated. With the synchronized acquisition of the parameters, a correlation of the corresponding parameters is enabled in a user-specific way; this avoids multiple measurements of the sample on different measuring devices and has the additional great advantage of synchronous detection in dynamically changing samples. This is in particular of interest against the background of possible bleaching and aging effects in case of multiple measurements.

Real-simultaneous acquisition is achieved when the beam splitter is embodied as a color or polarization splitter and when dispersion element, color or polarization filter in front of the two detectors are eliminated. The color splitter can be designed, for example, such that it separates FRET donor and FRET acceptor bands in order to achieve a loss-free (filterless) FRET system. In analogy, the beam splitter can separate the polarization directions in order to obtain a loss-free anisotropy system.

The combination of time, spectral and space analysis proposed herein combined with functional and structural information regarding the sample by means of external synchronized devices enables a highest possible sensitivity and selectivity as it cannot be achieved with conventional methods.

Object of the invention is also a method for simultaneous multi-channel acquisition of synchronized parameters from TSCSPC and external methods in fluorescence lifetime applications, comprising the steps:
irradiation of a sample with at least one pulsed high-frequency polarized or unpolarized ps laser beam;
emission of the fluorescence radiation from the sample wherein the fluorescence radiation is guided onto at least one beam splitter so that at least two partial beams are formed;
one or both partial beams are guided onto at least one list-mode detector based on space-correlated and time-correlated single photon counting wherein the at least one list-mode detector simultaneously acquires all physical parameters of each single photon and saves them in control electronics,
simultaneously, a determination of further parameters by at least one peripheral device of a peripheral system is realized, wherein the parameter acquisition is done synchronized by means of the peripheral devices of the peripheral system and the parameters of the sample detected by the peripheral device are saved; and
the saved parameters of the list-mode detectors, of the periphery are combined to a multi-parameter, multi-method acquisition system in 1-file method.

The term 1-file method in the meaning of the present invention is to be understood as saving synchronized data sets of TSCSPC system, peripheral system and external system in one file on a data processing device.

The systems described herein can be operated with only one TSCSPC detector but a second TSCSPC detector (or gated CCD camera) can be synchronized.

In one embodiment of the invention, simultaneous with the determination of the parameters of the peripheral system a determination of further parameters by at least one external device of an external system is carried out, wherein the parameter acquisition through the external devices of the external system is realized with synchronization and the parameters obtained through the external devices of the external system of the sample are saved and the saved parameters of the list-mode detectors and of the peripheral and external device are combined to a multi-parameter, multi-method acquisition system in a 1-file method.

In one embodiment of the invention, the at least two partial beams are directed onto at least two list-mode detectors wherein the latter simultaneously acquire all physical parameters of each single photon and save them in the control electronics.

In a further embodiment of the invention, as an external device, which determines further parameters of the sample by means of independent methods, a scanning force microscope, a laser scanning cytometer, a confocal one-photon or two-photo laser scanning microscope is used.

In one embodiment of the invention, individual applications of each branch are possible such as in a TSCSPC polychromator fluorescence microscope, by use e.g. of an imaging transmission polychromator or a fiber-coupled confocal spectrograph such as a Nikon C1s1 spectral imaging confocal system.

By simultaneous measurement of the time-resolved fluorescence images and the time-resolved fluorescence spectra, it is possible to eliminate the negative effects of auto fluorescence (e.g. FRET verification). The fastest component (approximately 100 ps) of auto fluorescence can mimic Förster resonance energy transfer (FRET) but can be recognized because of its much broader emission spectrum as auto fluorescence. Moreover, by the use of two excitation lasers, a simultaneous multi-channel acquisition of the donor-excited and acceptor-excited emissions can be achieved for a better understanding of the intrinsic FRET mechanism.

In one embodiment of the invention, furthermore synchronized coordinates and/or parameters of the periphery and external devices of the external system are acquired and combined with the saved parameters of the list-mode detectors to a multi-channel, multi-method and multi-parameter acquisition system, wherein the periphery encompasses all electronically controllable modules of a nanoscope, microscope or macroscope, such as an epi/TIRF fluorescence microscope (position of a filter wheel and/or of a dichroic carousel, position of the output port, z position of the lens, xyz position of a nano or micro translation stage, epi or TIRF position) and the external devices are selected from a group comprised of CCD camera, gated CCD camera, color of an electronically controlled color filter, laser in a multiple laser excitation (color of an electronically controllable ps continuum laser), properties of one or several additional manipulation lasers (trapping, cutting, activation, conversion, bleaching), xyz position and corresponding measured value of a scanning probe microscope (SPM), laser beam modifiers (structured illumination), rotating Nipkow disk with microlenses, 3-D-SIM microscope, ROI of a confocal scanning spectrograph.

In a further embodiment of the invention, the synchronized data and parameters of the TSCSPC system, of the periphery, and of the external system are combined to a multi-channel, multi-method and multi-parameter acquisition system and are used in a replay mode for functional and/or structural analyses, wherein the following methods can be used: TSCSPC nanotracking, TSCSPC-PSF (point spread function) analyses: TSCSPC-Palmira-FLIN (photoactivated localization microscopy with independently running acquisition-fluorescence lifetime imaging nanoscopy), TSCSPC-STICS (spatio-temporal image correlation spectroscopy), TSCSPC-OLID (optical-lock-in detection), TSCSPC-PALM/FPALM (photoactivation light microscopy), TSCSPC-STORM (stochastic reconstruction optical microscopy), TSCSPC-STED (stimulated emission depletion), TSCSPC-PAM (programmable array microscope), single plane illumination microscopy (optical sectioning microscopy), TSCSPC-FRAP (fluorescence recovery after photo-bleaching), TSCSPC-FRET (Förster energy resonance transfer) or also functional/structural correlations such as in case of combination of data of an AFM (as a component of the synchronized external system) with those of a TSCSPC system.

In one embodiment of the invention, simultaneously the excitation wavelength, the emission wavelength as well as the dichroic microscope mirror are changed. In this way, it is possible to employ for each excitation wavelength an optimized filter set resulting in brighter and contrast-enriched fluorescence images.

In one embodiment of the invention, the system according to the invention is used in macroscopy applications. They can be, for example, multi-well plate applications in the medical, biotechnological field as well as imaging endoscopy in medical applications wherein by use of the system according to the invention real-time images can be generated as well as in fluorescence imaging applications for small animals in the veterinary field or for research purposes.

In one embodiment of the invention, by means of 2-file method synchronized data quantities will be saved on a data processing device, wherein two PCs or one PC with multicore processor can be used.

In one embodiment of the invention, for a high data throughput >0.25×10⁶ cps of the TSCSPC branch, ps/ns time-resolved time lapse imaging in the range of video quality with 25 images/s or higher can be achieved in order to determine fast changes of the fluorescence dynamics during or after measurement. At high data throughput, e.g. of >10⁶ cps of the TSCSPC branch ps/ns time-resolved imaging in the range of video quality with 25 images/s or higher can be achieved in this way.

In one embodiment of the invention, the absolute arrival time of the TSCSPC parameter set is used for synchronization with periphery system and external system, wherein the arrival time is determined by a quartz clock or by means of the counted number of periodic excitation laser pulses.

In one embodiment of the invention, a widefield 2-photon excitation in an external TIRF prism with >100 mW IR laser power is carried out wherein switching between 1-photon and 2-photon excitation is done by synchronized switching of a frequency doubler of, the excitation laser.

In one embodiment of the invention, a focal lens in front of the TIRF prism provides the desired illumination surface and thus the excitation intensity.

TSCSPC is the imaging variant of TCSPC (time-correlated single photo counting), a tried-and-true ultrasensitive method in order to acquire fluorescence dynamics of highest quality, based on an MCP-PMT point detector with disk anode. The replacement of the disk anode by a space-sensitive delay line or multi-channel anode leads to TSCSPC (time-correlated and space-correlated single photo counting) which is the imaging variant of TCSPC. FLIM (fluorescence lifetime imaging microscopy) has been carried out up to now with TCSPC and by scanning of the focused laser beam which may cause undesirable side effects such as photodynamic reactions and bleaching of the sample etc. based on the very high excitation intensities within the focus. The TSCSPC method, on the other hand, employs imaging widefield detectors with minimal invasive widefield illumination that for the first time enables fluorescence measurements of living cells under physiological conditions. The TSCSPC method is ultrasensitive (individual molecule) and has an ultradynamic range (>10⁶) for a time resolution of <5 ps as well as spatial resolution of <80 microns at the photocathode (1200×1200 pixels) at a throughput of 10⁶ cps whereby video speed is achieved. The new widefield FLIM method achieves, for an instrument response function (IRF) of 25 ps FWHM, an effective time resolution of up to approximately 3 ps in multi-exponential fluorescence dynamics after deconvolution. In addition to high time resolution, this innovative widefield method, compared to already established optical methods that are based on the scanning principle, has the advantage of very minimal excitation intensity (minimal invasive). For the excitation only very low photon densities of 10¹⁰ photons/cm²/excitation pulse and minimal average intensities of 10 mW/cm² at multi-parameter data acquisition are required, i.e. 10³-10⁴ times less excitation intensity than in the classical fluorescence or laser scanning microscopy. Accordingly, an up to now unachieved high potential for the minimal invasive but physiologically relevant long-term observation of (biological) interaction processes, simultaneously on a large number of individual living cells, as well as on microstructures and nanostructures is made available. In this way, long observation periods (long-period observation, LPO) of macromolecular complexes in their natural environment without induction of photodynamic reactions or bleaching of fluorophores are enabled.

By application of the multi-channel and multi-method configuration presented here, a novel time-resolved widefield fluorescence image acquisition for ultra-parallel and minimal-invasive applications in macroscopy, microscopy, and nanoscopy is generated, wherein the new microscopic applications encompass ultra-parallel optical tomography, nano process control, real-time control of radioactive contaminants (Sr⁹⁰) in drinking water, ultraparallel microarray reading devices for pharmacy and bioanalysis such as genome and proteom research, as well as pharmaceuticals development and monitoring and detection of damages on cultured plants by environmental pollutants or increased UV loading, and wherein cross-system multi-parameter measured data acquisition in cell biology is enabled.

By synchronized combination of TSCSPC with modern nanoscopy methods, for the first time ps/ns time-resolved nanoscopy is achieved, i.e., FLIN (fluorescence lifetime imaging nanoscopy) as an expansion to classical FLIM. By synchronization with widefield nanoscopy methods such as STORM, PALM, PALMIRA, minimal-invasive widefield FLIN can be achieved for simultaneous nm distance determination and ps time measurement.

### BRIEF DESCRIPTION OF THE DRAWINGS

In the following, the invention will be explained with the aid of a few embodiments and corresponding Figures in more detail. The embodiments are provided to describe the invention without limiting it. It is shown in:

FIG. 1 a schematic illustration of a multi-channel, multi-method acquisition system according to the invention with 1-file saving for simple peripheral and external device configuration; in

FIG. 2 an alternative embodiment of a multi-channel, multi-method acquisition system according to the invention with 2-file saving for complex peripheral and external device configuration, in

FIG. 3 a schematic illustration of a possible laser arrangement in a multi-channel, multi-method acquisition arrangement with individual excitation lasers, in

FIG. 4 a schematic illustration of a further laser arrangement with broadband ps laser and wavelength selector in a multi-channel, multi-method acquisition arrangement, in

FIG. 5 an exemplary illustration of a detail of a list with “fast” and “slow” channels, in

FIG. 6 a combination of free beam and fiber microscope coupling of the excitation laser, in

FIG. 7 an exemplary typical multi-peripheral, multi-external device arrangement of an acquisition system according to the invention, in

FIG. 8 a schematic illustration of a simultaneous observation of fluorescence image by means of TSCSPC and external detectors, and in

FIG. 9 a schematic illustration of a microscopy application with a multi-well sample.

### DESCRIPTION OF PREFERRED EMBODIMENTS

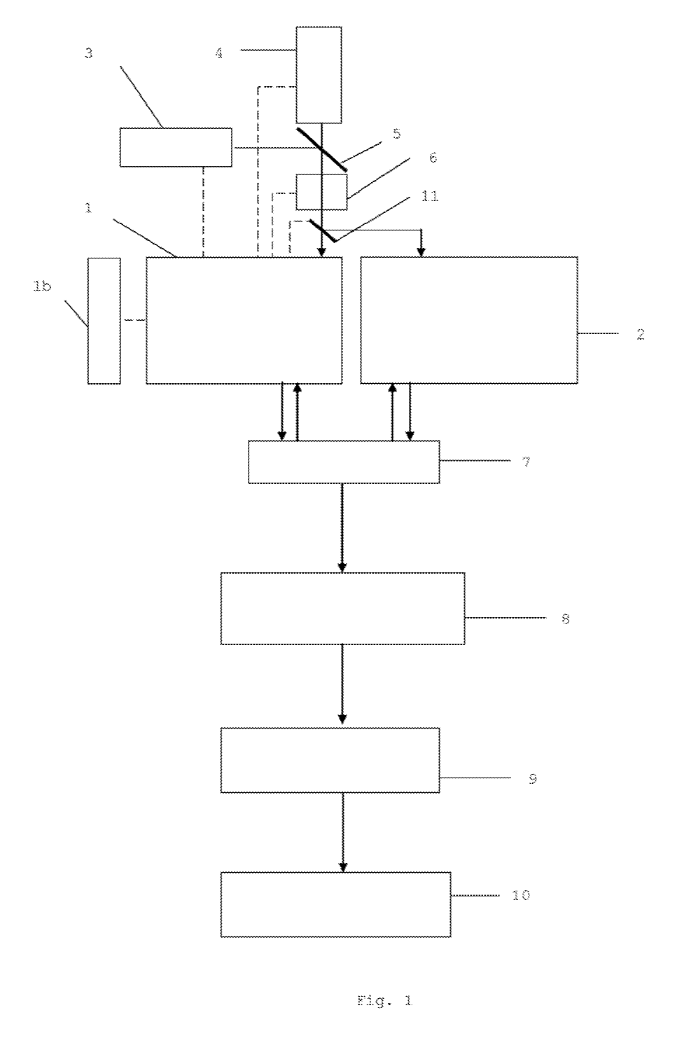

In FIG. 1, in an exemplary fashion, a multi-channel, multi-method acquisition system is illustrated. It comprises a TSCSPC system 1 with coupled optical system (nanoscope, microscope or macroscope) and detector head shutter 1b that, for example, can be embodied as a TSCSPC widefield fluorescence system. Moreover, peripheral devices, not shown in detail, and an external system 2 are provided wherein the external system 2 are configured for acquisition of further parameters of the sample by means of independent methods that are non-invasive. In this context, such an external system 2 may comprise external devices such as scanning spectrometers, scanning probe microscopes, laser scanning microscopes, laser scanning cytometers, confocal one-photon or two-photon laser scanning microscopes etc., or combinations of these devices, wherein the external devices of the external system 2 are those that enable detection of the parameters of the sample by means of non-invasive methods. The system comprises in this connection furthermore, for example, two ps excitation lasers 3, 4 that each emit at different wavelength ranges and in this way can realize different excitation areas within the sample. The emitted radiation of the two lasers 3, 4 can be superimposed colinearly by means of a beam splitter 5 which is embodied as a dichroic mirror, combined to a common beam and coupled into the optical system part (nanoscope, microscope, macroscope) of the TSCSPC system 1 after passing through an optional light manipulator 6 (structured light), wherein a portion of the laser beam by means of a splitter mirror 11 can be branched off and coupled into the external device 2.

The TSCSPC system 1, including the periphery, as well as the external system 2 are synchronized with each other by means of synchronizer 7 so that the data and parameters that are acquired in the TSCSPC system 1, in its periphery and the external system 2 can be correlated with each other subsequently. In this connection, the data and parameters of the TSCSPC system 1, of its periphery, and of the external system 2 are synchronized by means of the synchronizer 7, wherein the synchronizer 7 has a feedback function to the TSCSPS system 1 and the external system 2 in order to ensure synchronization of the acquisition processes of the respective systems 1, 2.

The combined synchronized data of the TSCSPC system 1 and of the external system 2 are converted by the synchronizer 7 into the synchronized data format 8. The data format of the TSCSPC method writes the TSCSPC parameters x, y, t(abs), and Δt (TSCSPC) of each individual event together with the corresponding values of the periphery (e.g. position of a filter wheel) and the external devices of the external system 2 (e.g. spatial coordinates and corresponding measured value of an AFM) sequentially into a list. The data are then transmitted to a data processing device 9, such as a PC, wherein a list of the individual events is saved, wherein each individual event carries the complete parameter set comprised of synchronized data of the individual TSCSPC/periphery channels as well as of the external devices of the external system 2. The synchronized data of the TSCSPC system 1, of the periphery, and of the external system 2 can then be replayed in replay mode 10 in any desired combination. This 1-file method is in particular suitable for limited periphery and external system 2.

As a result of the multi-channel, multi-method acquisition which can be realized by the system according to the invention, different new applications such as TSCSPC nanotracking, TSCSPC-PSF (point spread function) analyses, TSCSPC-Palmira-FLIN (photoactivated localization microscopy with independently running acquisition-FLIN=fluorescence lifetime imaging nanoscopy), TSCSPC-STICS (spatio-temporal image correlation spectroscopy), TSCSPC-OLID (optical-lock-in detection), TSCSPC-PALM/FPALM (photoactivation light microscopy), STORM (stochastic reconstruction optical microscopy), TSCSPC-STED (stimulated emission depletion), TSCSPC-PAM (programmable array microscope), optical sectioning microscopy (structures illumination), TSCSPC-FRAP (fluorescence recovery after photo-bleaching), TSCSPC-FRET (Förster energy resonance transfer) or also functional-structural correlations such as by combination of data of a scanning probe microscope (e.g. AFM, as a component of the synchronized external system 2 with those of a widefield fluorescence TSCSPC system 1) can be realized. In this way, user-specific new examination possibilities of a sample with non-invasive methods are provided, wherein, as a result of the possibility of the simultaneous or pseudo-simultaneous multi-channel, multi-method acquisition, multiple loading of the sample is avoided and processes that occur very quickly can be followed. With synchronization of the data and parameters, in addition to time information and spatial information relative to the fluorescence applications also different parameters of external devices of the external system 2 can be included in the evaluation. In this way, simultaneous or pseudo-simultaneous multi-channel and multi-method acquisitions of data and parameters are possible. In case of TSCSPC-AFM, this would be a simultaneous observation of function (TSCSPC) information and structure (AFN) information that otherwise is not accessible. In this scenario, the AFM probe is on the opposite side of the laser-illuminated sample.

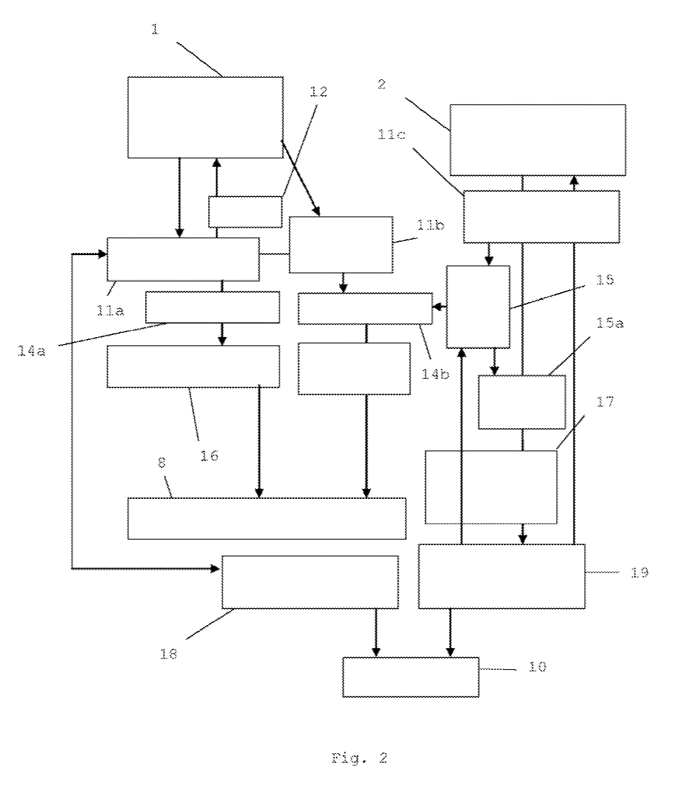

FIG. 2 shows schematically a possible configuration of a multi-channel, multi-parameter acquisition system which comprises a TSCSPC system 1 as well as a periphery and an external system 2. The data and parameters of each photo (quantum) detected by the TSCSPC system 1 are transmitted to the appropriate electronic device for determining the time information and spatial information 11a which, in turn, has a feedback function to the TSCSPC system 1. The thus gained data of the TSCSPC system 16 are then transmitted to the high-resolution “fast channels” of the TDC 14a. In addition to acquisition of time and spatial information as well as the absolute arrival time of each photon by the TSCSPC system 1, in the periphery further data and parameters of the periphery status PSN (periphery state number) are acquired which are transferred from the peripheral electronics 11b to the, for example, 12 low-resolution “slow channels” 14b of the TDC and, in the data format 8, are then further transferred to the TSCSPC-PC 18 in order to be saved. Simultaneously, the “slow channels” 14b receive a binary code number ESN (external state number) that describes the actual status of the external devices of the external system 2 and is generated by the external electronics 11c in the ESN generator 15 controlled by the data processing device 19. This ESN code number is transferred also simultaneously, together with the complete information ES information 15a, to the external PC 19 in order to be saved and guarantees complete synchronization of TSCSPC, periphery and external data in the replay mode 10 in which, as already described above, it can be combined and replayed in any desired user-specific combination. In this connection, the complete ES information 15a, containing all data and parameters of the external devices of the external system 2, is transferred to the data processing device of the external device 19 and saved therein, wherein the actual status of the external devices of the external system 2 is coded by the ESN and transferred to the slow channel electronics 14b. In this way, a correlation of the synchronized data and parameters between TSCSPC system 1 and external devices of the external system 2 is possible wherein the individual data and parameter sets of the TSCSPC system 1 as well as of the external devices of the external system 2 are saved on different data processing devices 18, 19 as separate data and parameter sets and a combination of the desired synchronized data and parameters in replay mode is possible, wherein the correlation is realized by means of the ESN. With this 2-file method, in case of a complex external device configuration 2, large synchronized data quantities can be saved on a data processing device 19 or on a peripheral data processing device without impairing the high throughput of >10⁶ cps (counts per second) of the TSCSPC branch. In this way, also the ps/ns time-resolved time lapse imaging in the range of video quality is possible, wherein at >0.25×10⁶ cps 25 images/s or more can be obtained in order to be able to determine fast changes of the fluorescence dynamics during measurement.

The PSN in this context are small binary numbers, limited currently to 12 channels, and the ESN is a consecutive number in binary or similar format.

Before the two data flows are saved on the fast hard drives of both data processing systems 18, 19 (or possibly on a single multicore PC), the data are loaded into RAM of the PCs where they are available for fast visual inspection.

The slow channel input of a TAC/ADC (time to amplitude converter (time amplitude converter)/analog digital converter) or TDC (time to digital converter (time digital converter)) 14 such as a TDC8HP card of Roentdek GmbH, is also referred to as “low resolution” channel because the time resolution is within the microsecond range while the time resolution of the “fast channels” of the TSCSPC system is below 1 ps.

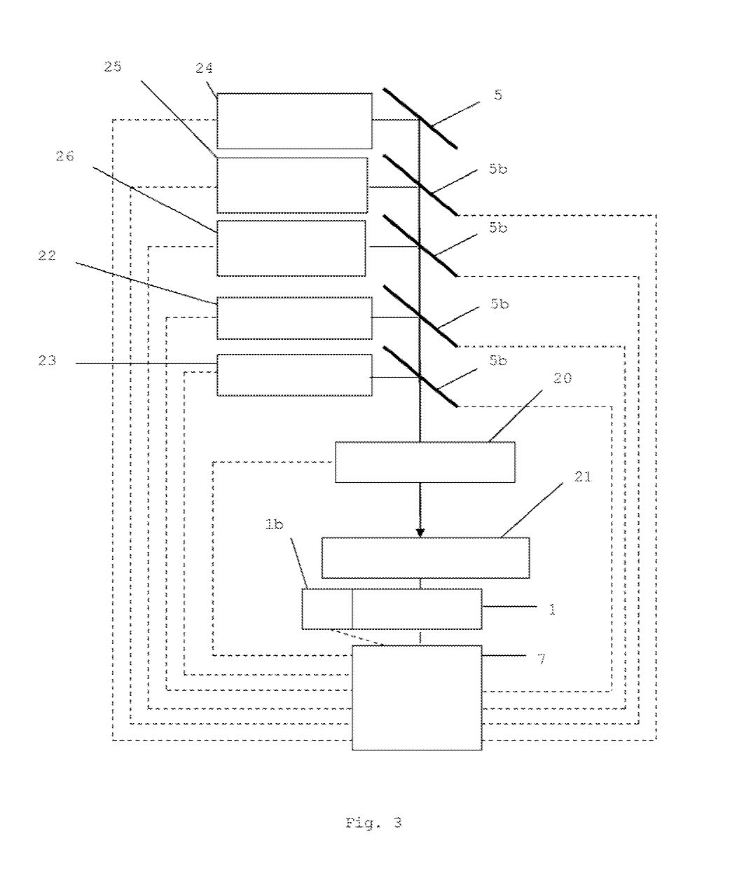

FIG. 3 shows a a possible configuration of a laser arrangement for a multi-channel, multi-method acquisition system, comprising a macroscope, microscope or nanoscope 21 with a TSCSPC system 1 together with detector head with synchronized protective shutter 1b as well as a plurality of excitation lasers that, as illustrated, can be embodied as a green, blue and red ps excitation lasers 24, 25, 26. The beams that are emitted by the excitation lasers 24, 25, 26 are combined colinearly by means of a number of dichroic beam splitters 5 and coupled into the optical system comprised of a macroscope, microscope or nanoscope. In addition, one or several manipulation lasers 22 as well as one or several activation lasers 23 can be coupled also. Moreover, the system can also comprise an excitation manipulator 20 which structures the light of the excitation laser 24, 25, 26 (structured illumination for increasing resolution). All lasers and correlated dichroics that are mounted on folding mirrors 5b are synchronized by the synchronizer 7. In this way, the synchronized parameters of the lasers 22, 23, 24, 25, 26 can be correlated with the respective data detected by the TSCSPC 1. The synchronized protective shutter 1b of the detector head is closed during manipulation and activation phases in order to protect the sensitive TSCSPC head from damage. The mirror 5 can be used for adjustment. By means of the different excitation wavelengths of the lasers 24, 25, 26, multi-channel acquisition can be performed simultaneously or pseudo-simultaneously when the periphery, i.e., the dichroic of the microscope (in the dichroic carousel) and the corresponding emission filters of a filter wheel are synchronized accordingly.

Manipulation and activation lasers 22, 23 can be arranged in series, as illustrated herein, or can also use different microscope inputs. An external serial connection ensures great variability for sequential and simultaneous excitation. The use of different microscope inputs can cause impairments and for this reason a synchronized microscope distribution cube 34 is required additionally that controls the individual outputs.

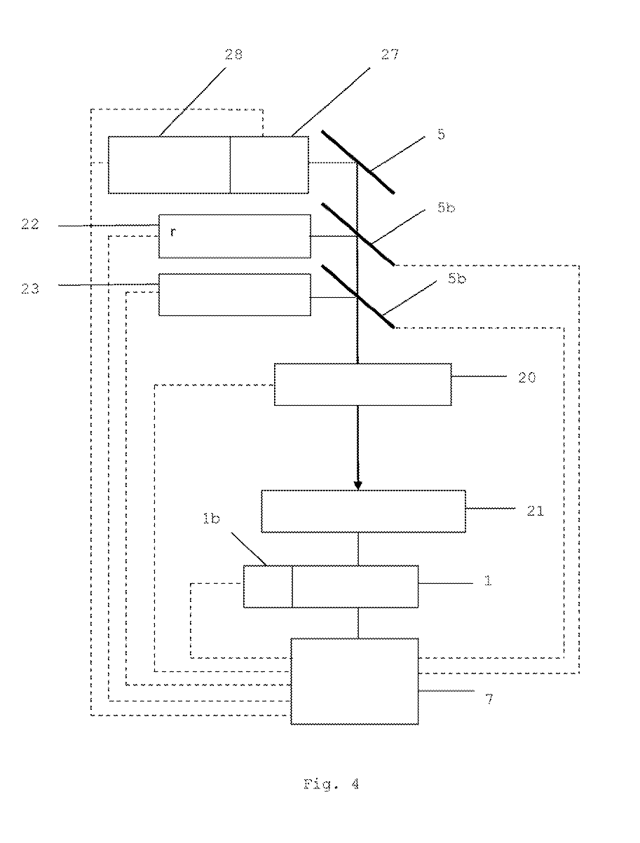

In FIG. 4, a modification of the multi-channel, multi-method acquisition system as disclosed in FIG. 3 is illustrated which, in addition to the macroscope, microscope or nanoscope 21 with the TSCSPC system 1, comprises also a synchronizer 7. The multi-channel acquisition is operated by a synchronized white ps excitation laser 28 which is connected with a synchronized wavelength selector 27. By means of the wavelength selector 27, any wavelength range can be selected and the samples can be irradiated with the selected wavelength range. The beam that is emitted by the excitation laser 28 is combined colinearly with the optional manipulation and activation lasers 22, 23 by use of dichroic mirrors 5b. In this connection, all of the aforementioned lasers 28, 22, 23, the wavelength selector 28, and the protective shutter of the detector head 1b are synchronized by the synchronizer 7 so that the data obtained through the TSCSPC system 1 can subsequently be correlated in replay mode 10 with the respective parameters of the lasers 22, 23, 28 and of the wavelength selector 28: The shutter 1b is shut during manipulation and excitation phases in order to avoid damage of the light-sensitive detector.

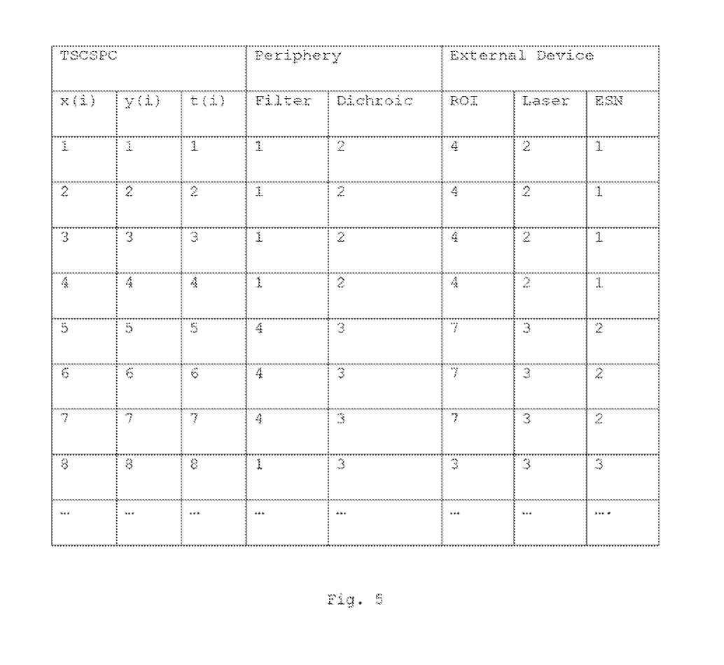

FIG. 5 shows an exemplary illustration of a detail of a list of “fast” and “slow” channels 14a, 14b. The TSCSPC coordinates (x, y, t) change very quickly (ps time resolution) and are different for each individual event. The periphery and external data (PSN and ESN) change in comparison thereto slowly and usually appear as groups. The example describes an 8-channel system with combinations of 2-laser excitations, 2-emission filters and 2-ROI (region of interest) of an external device 2. In the list-mode, the desired data can now be represented in any combination. For example, for the following replay sorting criteria filter=4, dichroic=3, laser=3, and ROI (region of interest)=7, the events i=5-7 would be selected.

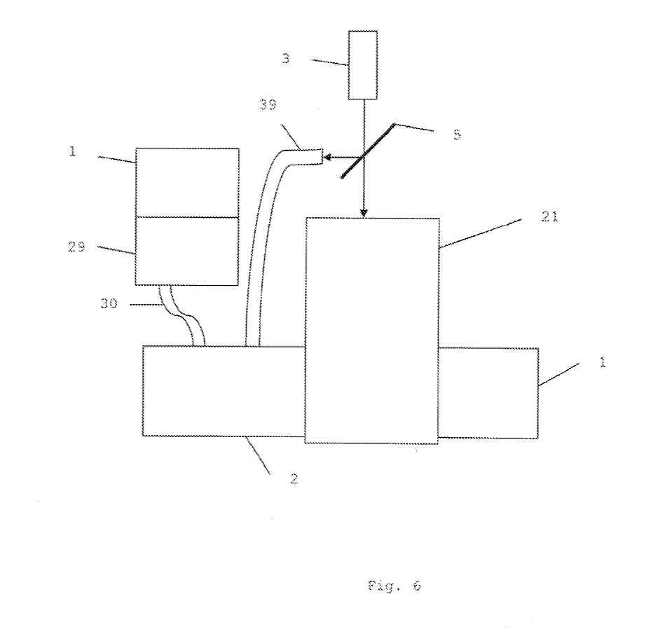

In FIG. 6, a combination of free beam and fiber microscope coupling of the excitation laser 3 that is split by the splitter mirror 5 is illustrated. In this connection, a part of the laser beam is guided onto the sample 31 in the macroscope, microscope or nanoscope 21 and the other partial beam is guided by means of a light guide to the external device of the external system 2 wherein the coupling action is realized by means of a fiber coupler 39. This example illustrates a combined TSCSPC application wherein the external device 2 is a Nikon confocal spectrometer Ci with ROI selector that is flange-connected to the TSCSPC system 1 that comprises a fluorescence microscope 21. As illustrated, two synchronized TSCSPC systems 1 can be employed wherein both are synchronized with the external device of the external system 2. Alternatively, only one TSCSPC system can be used sequentially which is facilitated by a quick release coupling such as an annular clamp on the detector head. Moreover, the external device of the external system 2 and a polychromator 29 are connected by means of a lightwave guide 30. The coupling of the free beam laser that is expanded by a laser telescope is realized by means of a tube lens.

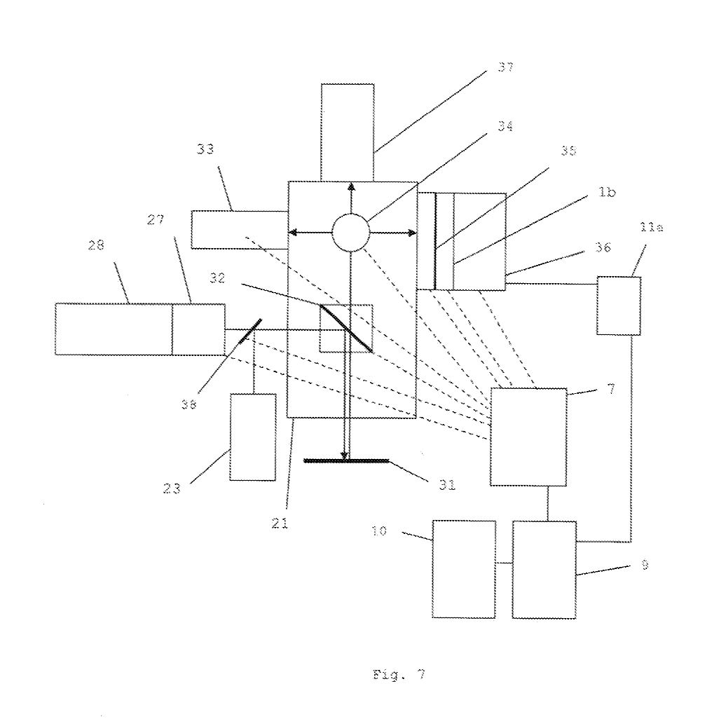

FIG. 7, on the other hand, shows an exemplary typical multi-periphery, multi-external device arrangement of the acquisition system according to the invention. In this context, a band of the white light continuum laser 27 that has been selected by the wavelength selector 28 impinges on the synchronized dichroic carousel 32 of the macroscope, microscope or nanoscope 21 which in the instant embodiment is an epifluorescence microscope and is reflected onto the sample 31 from where the emitted red-shifted fluorescence is passing through the dichroic 32 and impinges on the synchronized distributor cube 34 that deflects the fluorescence as needed into the lens 37, a ccd camera 33 or onto a filter wheel 35. Behind the filter wheel 35, there is a shutter 1b that protects the TSCSPC detector 1b, 36. The detector 36 is connected with the TSCSPC electronics 11a that is controlled by PC 9. All peripheral components such as 32, 34, 35 as well as the external devices 1b, 27, 28, 33, 36, 38 are connected to the synchronizer 7 that, in turn, is controlled by PC 9.

A typical application for a system according to FIG. 7 would be the synchronized periodic change of the wavelength selector 28, of the synchronized dichroic carousel 32 and of the synchronized filter wheel 35 for TSCSPC acquisition at different excitation and emission wavelengths which is optimized by the appropriately matched dichroic mirror, interrupted by periodic CCD images 33, and periodic activation phases by the flip mirror 38, with shutter 1b being shut.

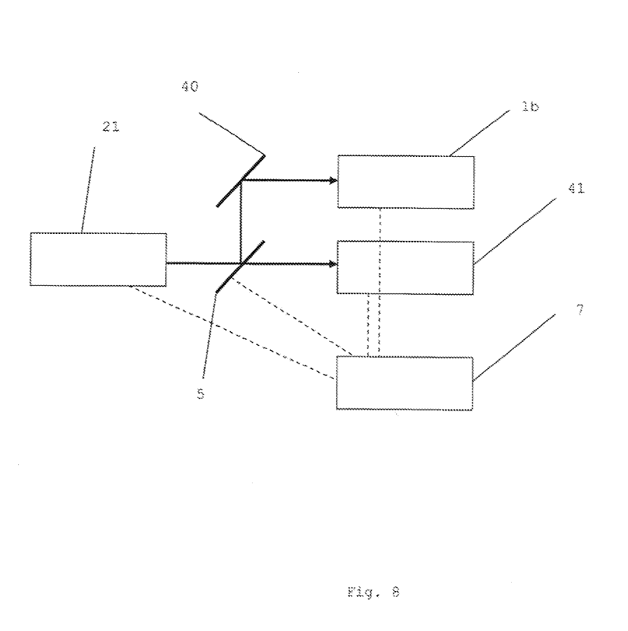

FIG. 8 shows an exemplary typical multi-peripheral, multi-external device arrangement of the acquisition system according to the invention. In this connection, a fluorescence image is transferred from the macroscope, microscope or nanoscope 21 onto a mirror 5 which is embodied as an intensity splitter so that the beam is split into two partial beams. One partial beam is deflected by a fully reflective mirror 40 onto a TSCSPC detector 36 with protective shutter 1b. The other partial beam is deflected onto a CCD detector 33 of the external system 2. The macroscope, microscope or nanoscope 21, the mirror, the TSCSPC detector as well as the CCD detector 33 are synchronized with each other by means of a synchronizer 7.

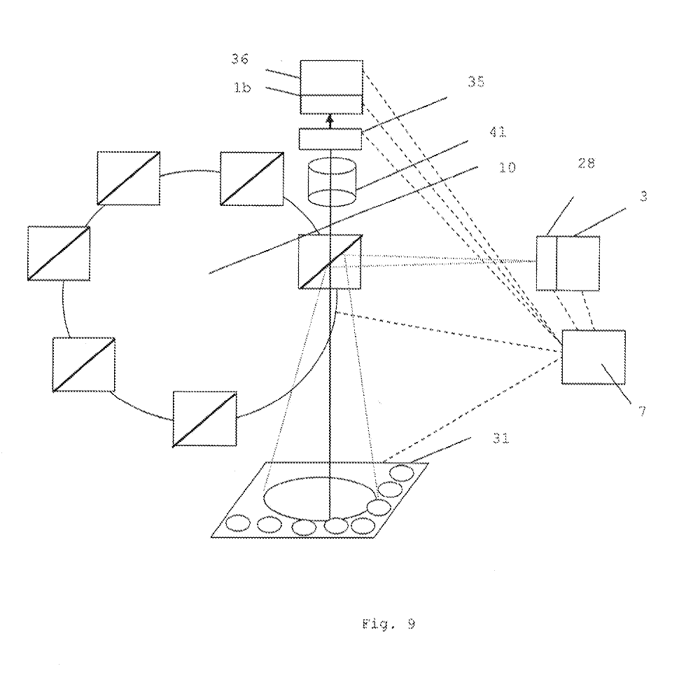

FIG. 9 shows a schematic illustration of a possible macroscopy application of the multi-channel, multi-parameter acquisition system according to the invention wherein the system a ps excitation laser 3 with wavelength selector 28 and widefield illumination. The laser 3 emits a beam onto a dichroic mirror of a dichroic carousel 10 by means of which the beam is deflected onto the sample 31. The sample 31 in the present case is embodied as a multi-well plate which, for example, comprises 4×5 wells and is arranged on an xy-adjustable sample stage. However, greater well numbers are possible also. The emission that is the result of the interaction with the sample 31 is deflected onto a powerful camera lens 41 and then onto a synchronized filter wheel 35, wherein as an alternative to the filter wheel 35 also an AOMF (acousto-optical modulated filter) bandpass filter may be used.

The emission is subsequently deflected onto a TSCSPC detector 36 with protective shutter 1b. In this connection, the TSCSPC detector 36 as well as the protective shutter 1b, excitation laser 3 as well as the wavelength selector 28 and dichroic carousel 10 as well as the xy-adjustable sample stage of the sample 31 are synchronized with each other by synchronizer 7.

### LIST OF REFERENCE NUMERALS

1 TSCSPC system with optical system (microscope, macroscope, nanoscope) and opto-electronic periphery

1b detector head with protective shutter

2 external device of an independent method

3 ps excitation laser 1

4 ps excitation laser 2

5 mirror

5n dichroic beam splitter

6 laser light manipulator

7 synchronizer

8 data format of the list-mode

9 data processing device

10 combined parameter output

11a TSCSPC electronics

11b periphery electronics

11c external electronics

12 control of the TSCSPC electronics

13 synchronizer

14a fast channel electronics

14b slow channel electronics

15 ESN generator

15a ES information

16 data of the TSCSPC system

17 “slow” discrete and/or continuous data

18 data processing device of the TSCSPC system

19 data processing device of the external device

20 excitation manipulator

21 macroscope, microscope, nanoscope

22 manipulation laser

23 activation laser

24 ps excitation laser blue

25 ps excitation laser green

26 ps excitation laser red

27 ps excitation laser white

28 wavelength selector

29 polychromator

30 light guide

31 sample

32 synchronized dichroic carousel

33 CCD camera

34 synchronized distributor cube

35 synchronized filter wheel

36 TSCSPC detector

37 ocular

38 flip mirror

39 fiber coupler

40 reflective mirror

41 powerful camera lens

What is claimed is:

1. A device for simultaneous multi-channel, multi-method acquisition of synchronized parameters in fluorescence lifetime applications, the device comprising
a fluorescence macroscope, microscope or nanoscope,
at least one pulsed laser source,
at least one beam splitter,
at least one TSCSPC (time- and space-correlated single photon counting) detector detecting first parameters of a sample, and
at least one synchronized peripheral device.

2. The device according to claim 1, further comprising an external system for determining further parameters of the sample, wherein the external system is embodied or modified to detect the further parameters in synchronization with the at least one TSCSPC detector and comprises at least one pulsed or non-pulsed laser as an external device.

3. The device according to claim 1, comprising at least two said TSCSPC detectors.

4. The device according to claim 2, wherein the external system further comprises a scanning probe microscope, a laser scanning cytometer, a confocal one-photon or two-photon laser scanning microscope, a color CCD camera, gated CCD camera, a b/w CCD camera, in combination with RGB filters in a synchronized filter wheel, the color of an electronically controlled color filter (e.g. AOTF, acousto-optical tunable filter), a laser in a multiple laser excitation, fiber switchers, the properties of one for several additional manipulation lasers, xyz position and correlated measured value of a scanning probe microscope, rotating Nipkow disk with microlenses, laser beam modifiers, rotators for control of circular neutral filters for adjustment of laser intensity, prisms embodied for rotation of the polarization direction.

5. The device according to claim 1, wherein the beam splitter is embodied as an intensity splitter, color splitter, or polarization splitter.

6. The device according to claim 1, comprising a shutter is arranged on the a detector head of the at least one TSCSPC detector.

7. The device according to claim 5, wherein at least one color splitter and a polarization splitter are connected in series so that at least four partial images are obtained in a square arrangement.

8. The device according to claim 2, wherein at least one device of the external system is connected by a fiber coupler with an excitation laser which is arranged on the TSCSPC system.

9. The device according to claim 2, wherein the external device of the external system is flange-connected to the TSCSPC system.

10. A method for simultaneous multi-channel, multi-method acquisition of synchronized parameters in fluorescence lifetime applications, the method comprising the steps:
irradiating a sample with at least one pulsed, high frequency, polarized or unpolarized ps or ns laser beam,
emitting fluorescence radiation from the sample and guiding the fluorescence radiation onto at least one beam splitter and forming at least two partial beams,
deflecting the two partial beams onto at least one list-mode detector that operates by space-correlated and time-correlated single photon counting and acquiring by the at least one list-mode detector simultaneously all physical parameters of each single photon and saving the physical parameters in control electronics,
simultaneously carrying out a determination of further parameters by at least one peripheral device of a peripheral system, wherein the further parameters are acquired by the peripheral devices in synchronization and the further parameters of the sample determined by the peripheral device of the peripheral system are saved, and
combining the saved parameters of the list-mode detectors and the saved further parameters of the peripheral device to a multi-parameter, multi-method acquisition system in a 1-file method.

11. The method according to claim 10, wherein simultaneously to the determination of the further parameters of the peripheral system a determination of additional parameters by at least one external device of an external system is realized, wherein the additional parameters are acquired by the external devices of the external system in synchronization and the additional parameters of the sample determined by the external device of the external system are saved and the saved parameters of the list-mode detectors and the further and additional parameters of the peripheral and external devices are combined to a multi-parameter, multi-method acquisition system in a 1-file method.

12. The method according to claim 11, wherein as an external device of an independent method of the external system a scanning probe microscope, laser scanning cytometer, a confocal one-photon or two-photon laser scanning microscope, a color CCD camera, a b/w CCD camera, a gated CCD camera, synchronized filter wheel, electronically controlled color filter, a laser with a multiple laser excitation, fiber switchers, manipulation laser, rotating Nipkow disk with microlenses, laser beam modifiers, a confocal scanning spectrograph or a prism for rotation of the polarization direction is used.

13. The method according to claim 11, wherein furthermore synchronized coordinates and/or parameters of the external devices of the external system are acquired and combined with the saved parameters of the list-mode detectors to a multi-parameter acquisition system, wherein the external devices of the external system are selected from the group consisting of CCD camera, gated CCD camera, position of a filter wheel and/or a dichroic carousel, color of an electronically controlled color filter, laser in a multiple laser excitation, properties of one or several additional manipulation lasers, xy position and z parameter of a scanning probe microscope, position of a nanoscope, microscope or macroscope xy translation stage, laser beam modifiers, rotating Nipkow disk with microlenses, z position of the Nipkow disk, 3-D SIM microscope.

14. The method according to claim 11, wherein the multi-parameter, multi-method acquisition system is used in a replay mode for functional and/or structural analyses, wherein these are selected from the group consisting of: TSCSPC-nanotracking, TSCSPC-Palmira-FLIN, TSCSPC-STICS, TSCSPC-OLID, TSCSPC-PALM/FPALM, TSCSPC-STORM, TSCSPC-STED, TSCSPC-PAM, single plane illumination microscopy, TSCSPC-FRAP, TSCSPC-FRET as well as TSCSPC-SPM.

15. The method according to claim 11, wherein the laser beam is split by a mirror into at least two partial beams, wherein one partial beam is deflected onto the sample in the macroscope, microscope or nanoscope and the other partial beam is deflected to the external device of the external system.

16. The method according to claim 11, wherein, in addition to the acquisition of time and space information of each photon by the TSCSPC system, further data and parameters of the periphery status are acquired in the periphery, which, in data format, are transferred to the data processing device of the TSCSPC system in order to be saved.

17. The method according to claim 11, wherein the individual data and parameters sets of the TSCSPC system as well as of the external devices of the external system are saved on different data processing devices as separate data and parameter sets and these data and parameters sets in replay mode are combined with each other in a 2-file method, wherein the correlation is realized by the ESN.

18. The method according to claim 11, wherein at least one color splitter and one polarization splitter are connected serially such that four partial images in a square arrangement are obtained wherein real-simultaneous dual anisotropy imaging is enabled.

19. The method according to claim 11, wherein two-channel or four-channel coincidence imaging with only one detector head is realized wherein two or four sets of crossed DL or other space-imaging anodes are employed adjacent or on top of each other, wherein each partial image is read out from its own DL set.

20. The method according to claim 11, wherein coupling of a laser beam into the external device of the external system is realized by means of a fiber coupler.

21. The method according to claim 11, wherein simultaneously a change of the excitation wavelength, of the emission wavelength as well as of the dichroic microscope mirror are carried out.

22. The method according to claim 17, wherein by means of 2-file method synchronized data quantities are saved on the data processing device or are saved on a peripheral data processing device.

23. The method according to claim 17, wherein, for high data throughput >0.25×10⁶ cps of the TSCSPC branch, ps/ns time-lapse imaging in the range of video quality with 25 images/s or higher can be achieved in order to determine quick changes of the fluorescence dynamics during or after measurement.

24. The method according to claim 10, wherein the absolute arrival time of the TSCSPC parameter set is used for synchronization with peripheral and external systems wherein the arrival time is determined by a quartz clock or by means of the counted number of periodic excitation laser pulses.

25. The method according to claim 10, wherein a widefield 2-photon excitation is realized in an external TIRF prism with >100 mW IR laser power, wherein switching between 1-photon and 2 photon excitation is done by synchronized switching of a frequency doubler of the excitation laser.

26. The method according to claim 25, wherein a focal line in front of the TIRF prism adjusts the desired illumination surface and thus the excitation intensity.
